(19) United States
(12) Patent Application Publication
(10) Pub. No.: US 2025/0091111 A1
(43) Pub. Date: Mar. 20, 2025

(54) ROLLER HEMMING DEVICE, ROLLER HEMMING METHOD AND METHOD FOR SETTING A HEMMING PROCESS

(71) Applicants: thyssenkrupp Automotive Body Solutions GmbH, Heilbronn (DE); thyssenkrupp AG, Essen (DE)

(72) Inventors: Denis BECKER, Losheim am See (DE); Benjamin SEHR, Losheim am See (DE); Alexander MATHIEU, Losheim am See (DE)

(73) Assignees: thyssenkrupp Automotive Body Solutions GmbH, Heilbronn (DE); thyssenkrupp AG, Essen (DE)

(21) Appl. No.: 18/884,568

(22) Filed: Sep. 13, 2024

(30) Foreign Application Priority Data
Sep. 15, 2023 (DE) 10 2023 125 038.8

(51) Int. Cl. B21D 19/04; B21D 39/02; B21D 43/00; B25J 11/00

(52) U.S. Cl. CPC B21D 19/043; B21D 39/023; B21D 43/003; B25J 11/005

(57) ABSTRACT

A method for setting a roller hemming process for hemming a plurality of identical component arrangements comprises guiding a hemming roller arranged on a robot by the robot in accordance with a predetermined hemming path for forming a hemming flange of a component of a component arrangement, wherein a hemming process force acting on the hemming roller by the robot during forming is detected, wherein the hemming process force can be changed by a corresponding control of the robot, and a target hemming quality to be achieved is predetermined. The robot is controlled to achieve the target hemming quality, taking into account the detected hemming process force and an actual geometry of a formed hemming flange resulting from the forming process.

### CROSS REFERENCE TO RELATED APPLICATION

This application is a U.S. Non-Provisional that claims priority to German Patent Application No. DE 10 2023 125 038.8, filed Sep. 15, 2023, the entire content of which is incorporated herein by reference.

### FIELD

The present disclosure relates to a method for setting a roller hemming process for hemming a plurality of identical component arrangements.

### BACKGROUND

Roller hemming is an established joining process in the automotive industry for the production of body parts in the direct and indirect visible area. The main field of application is the production of add-on parts such as tailgates, bonnets and doors.

In production lines in particular, where a high degree of flexibility is required in terms of variant diversity, hemming using a robot-guided roller, known as roller hemming, is preferred to conventional machine hemming. The basis for robot-guided roller hemming is a path modelled on the component contour, the so-called hemming path, which is used to guide the hemming roller to form the hemming flange. The forces applied to the component by the robot during this process depend on several factors, such as material, flange geometry, sheet thickness and the contour of the component. In addition, there are robot-specific “uncertainties”, such as fundamentally the system rigidity at the respective operating point and the path geometry accuracy of the respective robot types. In practice, these dependencies have so far required time-consuming optimization of the robot program during commissioning, in particular through indirect correction of the force and the flange contact points by means of a relative offset in relation to the neutral geometry path specified by CAD data (CAD: computer aided design). With this procedure, quality optimization is achieved by manually changing the offset of the robot path as specified by a specialist. Such interventions require a high level of process-specific expertise and regularly require many time-consuming and cost-intensive optimization loops until the target hemming quality is achieved.

DE 10 2010 051 025 B4 also discloses a roller hemming device with a hemming roller arranged on a robot hemming head of a hemming robot, a control unit and a measuring means. The measuring means comprises a position-determining part for determining a position of the hemming roller and a force-measuring part arranged between the hemming roller and a joint area of the hemming robot. The control unit is designed to control the position of the hemming roller, taking into account values provided by the measuring means, in such a way that the hemming roller implements a specification with regard to a forming force.

In addition, WO 2013/149894 A1 discloses a roller hemming device in which the hemming roller can also be controlled to achieve a predetermined forming force, wherein the control device required for this is designed to compensate for variable robot elasticities. This takes account of the fact that the hemming robot with its links and robot axes acts as an elastic system that has different spring stiffnesses depending on the axis position. In this way, setpoint inputs for a forming force can be specified for a given path and are implemented by the roller hemming device without interfering with the path programming of the hemming robot.

Against this background, the present invention addresses the problem of providing an improved method for setting a roller hemming process, an improved roller hemming process and an improved robot hemming device, which in particular enables automated optimization of a hemming quality and further advantageously also ensures that an achieved hemming quality can be maintained.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified illustration of an exemplary embodiment of a roller hemming device designed according to the invention;

FIG. 2 shows a perspective view of an exemplary embodiment for a robot hemming head of a roller hemming device designed according to the invention;

FIG. 3a shows a schematic representation of a component arrangement with recorded parameters relating to an actual geometry before a hemming operation;

FIG. 3b shows a schematic representation of a component arrangement with recorded parameters relating to an actual geometry after a pre-hemming operation;

FIG. 3c shows a schematic representation of a component arrangement with recorded parameters relating to an actual geometry after a final hemming operation;

FIG. 4 shows a schematic representation of a component arrangement with an optical system for detecting the actual geometry of a hemming flange;

FIG. 5a shows a schematic representation of an exemplary embodiment of a method according to the invention for setting a roller hemming process for hemming a plurality of identical component arrangements; and

FIG. 5b shows a flow diagram for explaining a further exemplary embodiment of a method for setting a roller hemming process for hemming a plurality of identical component arrangements according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The disclosure relates to a method for setting a roller hemming process for hemming a plurality of identical component arrangements, wherein a hemming roller arranged on a robot for forming a hemming flange of a component of a component arrangement is guided by means of the robot in accordance with a predetermined hemming path, wherein the robot can be controlled by means of a control unit to influence a hemming quality of the formed hemming flange, wherein a hemming process force acting on the hemming roller by the robot during the forming is detected and the hemming process force can be changed by a corresponding control of the robot by means of the control unit. Furthermore, the invention relates to a roller hemming process and to a roller hemming device which has a hemming robot with at least one hemming roller arranged on a robot hemming head, a control unit and a measuring means.

The proposed solution provides a method for the setting, in particular for the automated optimization, of a roller hemming process for hemming a plurality of identical component arrangements, wherein a hemming roller arranged on a robot for forming a hemming flange of a component of a component arrangement is guided by the robot in accordance with a predetermined hemming path. The robot can be controlled by means of a control unit to influence the hemming quality of the formed hemming flange, wherein an actual hemming process force acting on the hemming roller during the forming process is detected by the robot, and the actual hemming process force can be changed by a corresponding control of the robot by means of the control unit. The method also provides that a target hemming quality to be achieved is specified, in particular a target hemming quality to be achieved is specified by the control unit, the robot is controlled by the control unit to achieve the target hemming quality, taking into account the detected actual hemming process force and an actual geometry of a formed hemming flange resulting from the forming. In particular, the resulting actual geometry is measured after forming. The method advantageously runs through a number of iterations until a roller hemming process corresponding to a target hemming quality to be achieved is established. In this respect, the method steps are carried out repeatedly in particular, preferably repeatedly in an automated manner. The target hemming quality is defined in particular by a geometry of a formed hemming flange, wherein the following criteria in particular can be taken into account individually or in any combination: a roll-in value; a packing dimension; an outer radius; a position of the hemmed component in relation to a defined reference point; a flange length; a flange width. In addition, specifications can be made for the target hemming quality, in particular with regard to the occurrence of cracks in the formed hemming flange, specifications with regard to a waviness of the formed hemming flange and/or specifications with regard to surface problems of the formed hemming flange. The method is envisaged in particular for setting or optimizing a roller hemming process for body component arrangements in series production.

In particular, the invention advantageously provides that a control method for the at least partially automated setting, in particular for the at least partially automated optimization, of a roller hemming process is created by means of a data-based recording and evaluation of the relevant influencing variables, in particular the real hemming process force, further in particular the real hemming process force and its dispersion, and advantageously the hemming flange geometry. Preferably, a corresponding recommendation for action is first made with regard to the measures required for setting or optimizing, in particular influencing the hemming forces, in particular a change in the hemming forces due to a change in the robot path and/or a change in the engagement positions of the hemming surfaces during robot-guided hemming. Subsequently, the system-side recommendations for action are advantageously mapped autonomously. In particular, self-learning algorithms, which can be designed specifically for the application, can be used to reduce the necessary setting or optimization loops.

Advantageously, the hemming path is also detected during the forming of the hemming flange. In particular, it is envisaged that the specified hemming path is detected by reading out the data relating to the specified hemming path. It is particularly advantageous for the hemming path to be recorded as a number of discrete values, in particular points. According to a further advantageous embodiment, the actual hemming path, i.e. the actual hemming path for a hemming operation, is recorded. The hemming path is advantageously detected by determining it from the detected actual hemming process force and the detected actual geometry. Alternatively, or additionally, an actual hemming path can also be detected by measurement, in particular by means of optical sensors, in particular by means of at least one camera. In particular, in this configuration, each hemming roller is assigned its own camera and calibrated accordingly. Advantageously, this optical sensor system can also be used to measure the component. It is also advantageous to detect the position of the inner part for assembly via the position of the respective mounting holes using an optical system, in particular using the aforementioned optical sensor system. In particular, it is envisaged that points of the actual hemming path, in particular support points of the actual hemming path, and advantageously the roller displacements applied in the process are detected as part of the detection of the hemming path. By detecting the hemming path, it is advantageous to be able to assign the measured actual hemming process force to the path points, in particular via a time-based correlation. By detecting and recording the applied path displacements, a stiffness model is advantageously created at the respective path point. Advantageously, a roller hemming process can thus be set even more quickly.

According to a particularly advantageous embodiment of the method, the hemming path for controlling the robot by means of the control unit is described by a finite number of points representing the hemming path. Advantageously, the hemming path is clearly defined by means of these points. Advantageously, at least one property can thus be assigned to each point of the hemming path. Another advantage is that a roller hemming process can be set or optimized with high precision.

Advantageously, a target hemming process force is assigned to the hemming path. In particular, it is envisaged that a target hemming process force is assigned to each point of the hemming path. A target hemming process force is thus advantageously specified for the entire hemming path, with which a hemming operation is to be carried out. The target hemming process force can be specified in particular via the control unit. In particular, the target hemming process force can be specified via a man-machine interface, in particular an initial target hemming process force. In addition, an advantageous embodiment provides that the roller hemming process to be set is simulated by means of a computer-aided simulation, wherein the target hemming process force assigned to each point of the hemming path is advantageously provided from this simulation, in particular as initial process control parameters, and is advantageously automatically assigned to the points.

It is also advantageous to assign an actual hemming process force to the hemming path. Preferably, an actual hemming process force recorded at this point is assigned to each point of the hemming path. The actual hemming process force is advantageously measured during the forming of a hemming flange. In particular, a measuring element is arranged between the robot flange and the hemming roller so that a force flow can be channelled through the measuring element. According to an advantageous embodiment, the robot comprises a robot hemming head with an attachment element, a connecting element and a head element on which the hemming roller is arranged. The connecting element is advantageously arranged between the attachment element and the head element, wherein at least a part of the connecting element is designed as a measuring body. The measuring body with at least one sensor element arranged on the measuring body advantageously detects the actual hemming process force. It is therefore particularly envisaged that the actual hemming process force is recorded online, i.e. during the forming of a hemming flange, and is advantageously assigned to the current position of the hemming path. Advantageously, by analyzing the deviation between the actual hemming process force and the target hemming process force, the robot can be controlled in such a way that the actual hemming process force is brought closer to the target hemming process force. The roller hemming process can thus be advantageously optimized.

Furthermore, the method advantageously provides that the hemming path is assigned a target geometry for a formed hemming flange, in particular a target geometry as the target hemming quality to be achieved. In particular, each point of the hemming path is assigned a target geometry for a formed hemming flange, with the target hemming quality to be achieved preferably being specified by the assigned target geometry.

Advantageously, the target hemming quality is therefore specified by assigning a target geometry for a formed hemming flange to each point of the hemming path. In particular, the target geometry comprises the following parameters individually or in any combination: a roll-in value; a packing dimension; an outer radius; a position of the hemmed component in relation to a defined reference point; a flange length; a flange width. In this respect, a large number of parameters can be assigned to a point on a hemming path.

It is particularly advantageous to record an actual geometry for a formed hemming flange. A detected actual geometry of a formed hemming flange is then advantageously assigned to the hemming path. In particular, an actual geometry of a formed hemming flange detected at this point is assigned to each point of the hemming path. The detection of an actual hemming process force with additional detection of an actual geometry for a formed hemming flange is particularly advantageous, because in this way a roller hemming process with a predetermined target hemming quality can be set more quickly, which advantageously makes the setting of the roller hemming process more cost-effective. In particular, it is envisaged that the actual geometry is recorded after the forming of a hemming flange in accordance with the specified hemming path has been completed. For this purpose, it is particularly envisaged that the actual geometry is recorded with a separate measuring run, which is assigned to the specified hemming path, wherein the measuring run is carried out in particular by means of the robot. The geometry, in particular the actual geometry for a formed hemming flange, is preferably recorded by means of an optical system, in particular using an optical method, in particular by means of laser triangulation or in a camera-based manner. Alternatively or additionally, the actual geometry of a formed hemming flange can be recorded using a haptic system, in particular using a tactile measuring device. In particular, a measuring roller or a measuring roller arrangement can be moved along the formed hemming flange for this purpose.

According to an advantageous variant, however, it is also provided that the actual geometry for a formed hemming flange is detected online, i.e. during a hemming process and thus in particular substantially directly after a hemming flange has been formed. Particularly in the case of such online detection, it is advantageously provided that a multi-camera arrangement detects a hemming flange that is located directly in front of a hemming roller position and directly behind the hemming roller position, wherein the detected image data are analyzed in particular to determine the actual geometry. The multi-camera arrangement is preferably arranged on the robot, in particular on the robot head.

A further advantageous embodiment provides for the detection of an actual geometry for a still unformed hemming flange, i.e. advantageously an actual geometry before the hemming flange is formed, in particular an actual geometry of a hemming flange that has not yet been completely formed, i.e. a pre-hemmed hemming flange. Advantageously, each point of the hemming path is assigned an actual geometry for the still unformed hemming flange recorded at this point. Advantageously, this configuration can therefore be used to detect an original state of a hemming flange before forming or further forming of the hemming flange. For this purpose, it is particularly envisaged that the actual geometry is recorded with a separate measuring run, which is assigned to the specified hemming path, wherein the measuring run is carried out in particular by means of the robot. Preferably, one or any combination of the following parameters relating to the actual geometry is recorded before the hemming flange is formed: an opening angle; a flange length; a pre-hemming angle achieved; a position of the unhemmed component in relation to a defined reference point; a position of the pre-hemmed component in relation to a defined reference point; a block clearance dimension. The actual geometry before forming of the hemming flange is advantageously recorded using the same measuring technology as the actual geometry after forming of the hemming flange. The geometry, in particular the actual geometry before the hemming flange is formed and/or the actual geometry of a formed hemming flange, is therefore advantageously recorded by means of an optical system and/or by means of a haptic system. Advantageously, at least one of the following criteria is recorded for the geometry: a roll-in value; a packing dimension; an outer radius; a pre-hemming angle achieved; an opening angle; a position of the unhemmed component relative to a defined reference point; a position of the hemmed component relative to a defined reference point; a block clearance dimension; a flange length; a flange width.

A valid stiffness model for the robot is also advantageously assigned to the specified hemming path. Advantageously, the stiffness model takes into account the individual arrangement of a hemming roller on the robot, in particular on the robot flange. Preferably, a stiffness or spring constant applicable to this point is assigned to each point of the hemming path. In particular, it is possible to use the recorded stiffnesses to create a model that can be used to improve the response to a target hemming quality specification, such as “roll in two-tenths of a millimetre less”, so that a corresponding hemming process can be set more quickly. In particular, the stiffness model advantageously helps to compensate for the different stiffnesses or the different spring constants of the robot depending on the position of the individual robot links and the stretch of the robot. In particular, a spring constant for the robot that applies to this point can be assigned to each point of a specified hemming path for the characteristic map.

To achieve the target hemming quality, and thus in particular to bring the actual hemming quality closer to the target hemming quality, and further in particular to bring the actual geometry closer to the target geometry, an adjustment of the hemming roller is advantageously varied in the method, wherein the variation of the hemming roller preferably takes place via the robot. By varying how the hemming roller is positioned in relation to the hemming flange to be formed, the hemming process force can advantageously be influenced. Furthermore, a flange opening angle can be influenced accordingly, in particular by changing the position of the hemming roller.

A further advantageous embodiment of the method provides that the actual variable detected in a first hemming operation, in particular the detected actual hemming process force and/or the detected actual geometry of a formed hemming flange, is brought closer to the target variable, in particular the target hemming quality, in particular the target geometry and/or the target hemming process force, in a subsequent second hemming operation. In particular, it is envisaged that a hemming flange of a first component arrangement is formed in the first hemming operation and a hemming flange of a second component arrangement is formed in the second hemming operation. Furthermore, however, it is also envisaged in particular that in the first hemming operation a hemming flange of a first component arrangement is formed as part of a pre-hemming process and in the second hemming operation this hemming flange of the first component arrangement is formed as a further (pre-) hemming step. The actual variable can therefore be brought closer to the target variable in particular via several pre-hemming operations and/or via a large number of final hemming operations, i.e. in particular in an iteration process. In this embodiment, the actual variable is not brought closer to the target variable during an ongoing hemming operation. However, such a configuration can be provided for quicker setting of a roller hemming process if the actual geometry is recorded online. Advantageously, in such an embodiment it is then provided that, taking into account actual variables recorded during a first hemming operation for points of the hemming path that have already been hemmed, the robot is controlled for subsequent points of the hemming path with the aim of reducing the difference between actual variables and target variables.

According to a further particularly advantageous variant of the method, the hemming process, in particular the roller hemming process to be set, is additionally simulated in a computer-aided simulation model. In particular, the simulation can be carried out in parallel with the actual hemming operation, which means in particular that a large number of these simulations can be carried out in parallel with a real hemming operation. Advantageously, actual variables recorded during the execution of the real method, in particular the actual hemming process force and/or the actual geometry of a formed hemming flange and/or the actual geometry of a still unformed hemming flange, are transferred to the simulation model. Variables for the actual variables on which the simulation model is based, which may in particular be based on calculations carried out, are then advantageously replaced by the transferred actual variables. Taking these actual variables and the target hemming quality to be achieved into account, the robot is then advantageously used to simulate an adjustment of the hemming roller, in particular until the target hemming quality is achieved in the simulation model. The next real hemming operation for setting the roller hemming process is then advantageously carried out with this simulated positioning of the hemming roller. Advantageously, this allows a roller hemming process to be set even more quickly. Another advantage is that the simulation can be carried out in advance of the real hemming process, in particular in addition to a parallel execution. Advantageously, certain simulation values are specified by the computer-aided simulation model as initial process control parameters for the method for setting a roller hemming process. Advantageously, this allows a roller hemming process to be set even more quickly.

In particular, it is provided that the method for setting a roller hemming process is carried out as a method for optimizing a hemming quality, in particular for a subsequent roller hemming of a plurality of identical component arrangements, and/or as an intermediate method for ensuring a hemming quality, in particular during a roller hemming process that has already been set.

Furthermore, a roller hemming method for hemming, in particular for at least partially automated hemming, of a plurality of identical component arrangements is proposed, wherein a hemming roller arranged on a robot for forming a hemming flange of a component of a component arrangement is guided by means of the robot in accordance with a set roller hemming process with a predetermined hemming path, wherein the roller hemming process is set in accordance with a method designed according to the invention. The roller hemming process is set in particular before the start of the hemming of the plurality of the same component arrangements for production and/or during the hemming of the plurality of the same component arrangements for production, wherein in this case it is advantageous to further contribute to ensuring a consistent hemming quality.

In addition, a roller hemming device is proposed which comprises a hemming robot with at least one hemming roller arranged on a robot hemming head, a control unit, and a measuring means, wherein the roller hemming device is designed to carry out a method according to the invention. In particular, it is provided that the roller hemming device comprises a first measuring means for detecting a hemming process force and a second measuring means for detecting a hemming geometry, in particular an actual geometry of a formed hemming flange and/or an actual geometry of a still unformed hemming flange. In particular, it is further provided that the hemming robot comprises a robot hemming head with an attachment element, a connecting element and a head element on which the hemming roller is arranged. The connecting element is advantageously arranged between the attachment element and the head element, wherein at least part of the connecting element is designed as a measuring body. The measuring body with at least one sensor element arranged on the measuring body is advantageously designed to detect an actual hemming process force, and thus in particular as the first measuring means. The second measuring means can advantageously comprise an optical system and/or a haptic system, wherein the respective system is set up to detect the actual geometry, in particular by means of laser triangulation or in a camera-based manner. Advantageously, a multi-camera system can be comprised by the roller hemming device as the second measuring means, wherein the multi-camera system preferably is arranged on the robot hemming head.

Further advantageous details, features and embodiment details of the invention are explained in greater detail in conjunction with the exemplary embodiments shown in the figures, in which:

In the various figures, like parts are generally provided with like reference signs and are therefore sometimes only explained in conjunction with one of the figures.

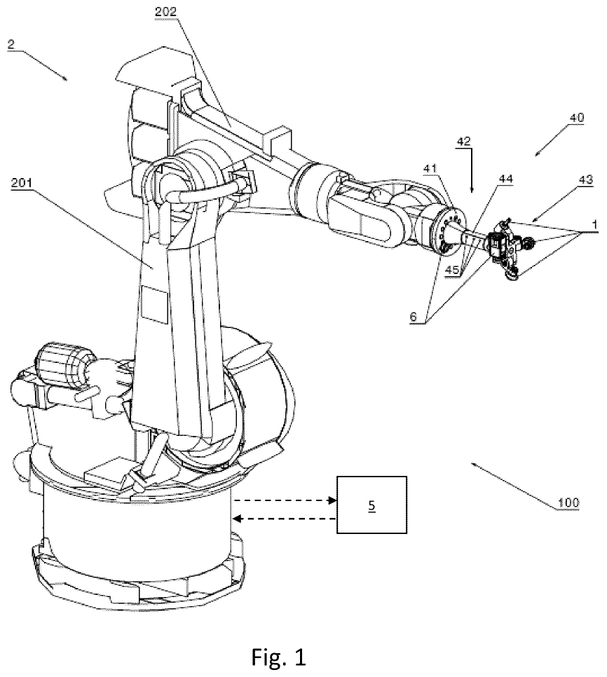

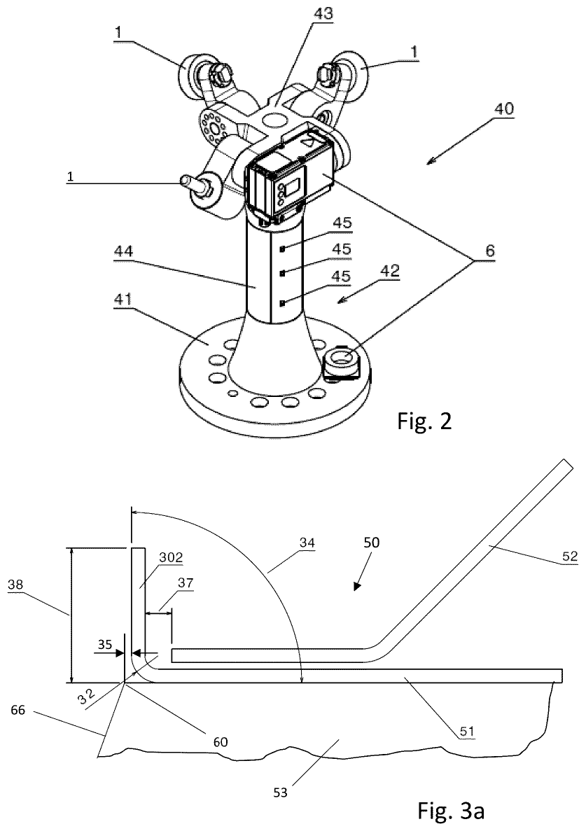

FIG. 1 shows a schematic representation of an exemplary embodiment of a roller hemming device 100 designed according to the invention with a hemming robot 2 and a control unit 5. The robot 2 comprises an articulated robot arm, which in this exemplary embodiment comprises a first link 201 and a second link 202. A robot hemming head 40 is arranged at the end of the robot arm. A force flow from the robot flange to the hemming roller 1 is channelled through a measuring unit to detect an actual hemming process force. An example of an advantageous design for a robot hemming head 40 is shown in FIG. 2. The robot hemming head 40 comprises an attachment element 41, a connecting element 42, a head element 43, which can in particular be designed as a single-piece component, and several hemming rollers 1, which are each arranged on the head element 13 and which can each be used for different hemming operations. The connecting element 42 is arranged between the attachment element 41 and the head element 43. The connecting element 42 is designed as a measuring body 44, wherein the measuring body 44 is designed with several sensor elements 45 arranged on the measuring body 44 for detecting the hemming force (actual hemming force) exerted on a hemming flange by one of the hemming rollers 1 during a hemming operation. In this exemplary embodiment, the measuring body 44 together with the sensor elements 45 form a sensor unit for detecting the hemming force. A component arrangement arranged on a hemming bed can be hemmed by means of a respective hemming roller 1. Such a component arrangement comprises in particular a first component and a second component, further in particular a first body component and a second body component for a motor vehicle.

By folding over a component edge of the first component using one of the hemming rollers 1, the first component and the second component can be joined together according to a predetermined hemming path. During this joining process, an actual hemming process force can be detected by means of the measuring body 44 and the sensor elements 45 arranged thereon. The hemming path is described by a finite number of points representing the hemming path for control of the robot 2 by means of the control unit 5. A detected actual hemming process force is assigned to each point of the hemming path during the joining, i.e. during hemming. In addition, the robot hemming head 40 comprises a sensor device 6, in particular an optical system, for digital geometry and position detection by means of laser triangulation. By means of this sensor device 6, the roller hemming device 100 is designed to detect the geometry of an unformed and a formed hemming flange of the component arrangement. In this exemplary embodiment, the robot 2 to this end performs an extra measuring run, which is specified by the hemming path, without hemming. Advantageously, the roller hemming device 100 is designed to carry out a method according to the invention. Further details of an advantageous embodiment of the robot hemming head 40 of the robot 2 of the roller hemming device 100 are explained with reference to FIG. 2.

As shown in FIG. 2 by way of example, the robot hemming head 40 comprises an attachment element 41, a connecting element 42, a head element 43 and a plurality of hemming rollers 1, wherein the connecting element 42 is arranged between the attachment element 41 and the head element 43, and the hemming rollers 1 are arranged on the head element 43. The hemming rollers 1 have different designs and are arranged in a star shape on the head element 43, wherein different hemming operations can be carried out using a robot 2 by means of the differently designed hemming rollers 1, in particular hemming operations adapted to different component arrangements and/or to different component geometries. Part of the connecting element 42 of the robot hemming head 40 is designed as a measuring body 44, wherein several sensor elements 45, in particular several strain gauges with preferably different orientations, are arranged on the measuring body 44. The measuring body 44 forms a sensor unit with the sensor elements 45, which is designed to detect the hemming process force exerted on a hemming flange by one of the hemming rollers 1 during a hemming operation. As shown in FIG. 2, the measuring body 44 can be column-shaped in particular. In addition, the measuring body 44 is designed to be elastically deformable, wherein the sensor elements 45 attached to the measuring body 44 are designed to detect an elastic deformation of the measuring body 44. The measuring body 44 can advantageously be constructed like a framework by means of recesses and struts (not explicitly shown in FIG. 2), and in particular has a defined elastic deformation behaviour, so that any deformations that occur can advantageously be clearly assigned to specific hemming process forces.

In this exemplary embodiment, the attachment element 41 of the robot hemming head 40 is designed as a docking plate with which the robot hemming head 40 can be arranged on a robot arm of a robot 2, as shown in the exemplary embodiment in FIG. 1. A computing unit (not explicitly shown in FIG. 2) can be arranged on the robot hemming head 40 and is designed to detect and process sensor signals provided by the sensor elements 45 and to forward the data processed in this way to a control unit 5 of a roller hemming device 100, as shown in FIG. 1 as an example, for further use. In particular, however, it is also envisaged that the sensor signals are transmitted directly to a control unit 5 of a roller hemming device 100. Depending on the embodiment, the computing unit or the control unit 5 advantageously comprises a microprocessor unit and a measuring amplifier (microprocessor unit and measuring amplifier not explicitly shown in the figures) for processing the (strain) signals recorded on the measuring body 44. Advantageously, a target hemming process force curve of a hemming force for predetermined hemming paths is also saved in the control unit 5 and, for this purpose, stored in a corresponding memory unit of the microprocessor unit. A respective hemming path is represented in the control unit 5 by a plurality of points, wherein each of the points is assigned a target hemming process force for the respective point.

The computing unit or the control unit 5 is also designed to detect an actual hemming process force curve during a hemming operation from the sensor signals detected by means of the sensor elements 45 arranged on the measuring body 44. It is envisaged that when a hemming operation is carried out in accordance with a predetermined hemming path, wherein one of the hemming rollers 1 of the robot hemming head 40 is guided along a component arrangement in accordance with a predetermined hemming path, the actual hemming process force occurring at these points is determined for the respective points of the hemming path, and the recorded values for the hemming process force are assigned to the points of the hemming path. The value assignments are advantageously stored and the overall curve of the actual hemming process force then results from the stored value assignments.

The control unit 5 is further designed to compare the detected actual hemming process force with a target hemming process force stored in the control unit 5 and to detect deviations between the actual hemming process force and the target hemming process force. Taking into account these detected deviations, a subsequent hemming operation is adapted using the control unit 5 in such a way that the actual hemming process force curve then detected deviates less from the target hemming process force curve, wherein the control unit 5 advantageously also takes into account the actual geometry of a reshaped hemming flange detected by means of the sensor device 6 when adapting the hemming process force applied by the hemming roller 1 by changing the position of the hemming roller 1 by means of the robot 2. Further advantageously, the actual geometry of a still unformed hemming flange is also taken into account, at least during an initial hemming operation, if there are several pre-hemming operations. In particular, the control unit 5 is designed to control the corresponding actuators of the hemming robot 2, which can be used to influence how the hemming roller 1 acts on the hemming flange to be formed.

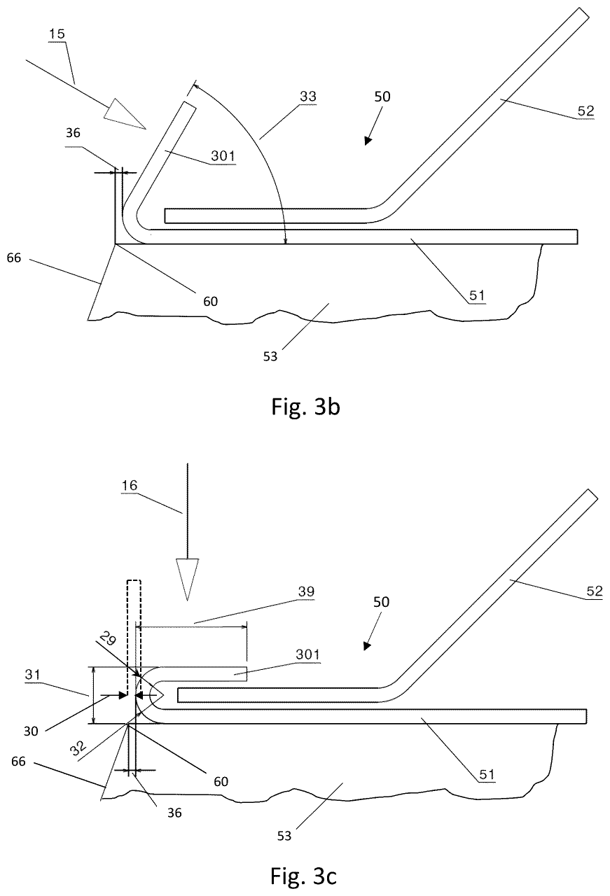

Parameters of the actual geometry of an unformed hemming flange 302 and a hemming flange 301 partially formed in a pre-hemming operation and a completely formed hemming flange 301, which are advantageously recorded as actual geometry individually or in combination, are shown in FIG. 3a, FIG. 3b and FIG. 3c. FIG. 3a to FIG. 3c each show a component arrangement 50 with a first component 51 and a second component 52, wherein the component arrangement 50 is arranged on a hemming bed 53. The point 60 drawn in FIG. 3a to FIG. 3c, as the upper edge of the hemming bed 53, represents a reference point in relation to which some of the parameters are recorded. The side surface 66 of the hemming bed 53 serves as a further reference surface with regard to the recorded parameters. The parameters can be recorded in particular by means of an appropriately equipped measuring means, in particular using an optical measuring method, and/or by reading in corresponding specifications if parameters, such as the flange length 38, are known in advance with low tolerances.

The parameters that are relevant in relation to the component arrangement according to FIG. 3a, i.e. before a hemming operation and therefore with a still unformed hemming flange 302, are the hemming length 38, the so-called block clearance dimension, i.e. the distance between the still unformed hemming flange 302 and the end edge of the portion of the second component 52 to be enclosed by the fully formed hemming flange, the opening angle 34, i.e. the angle at which the still unformed hemming flange 302 is set relative to the first component 51 resting against the second component 52, and the outer radius 32, which is described by the still unformed hemming flange 302 and the first component 51 resting against the second component 52. In addition, the position 35 of the unhemmed component 51 relative to the defined reference point 60 is recorded.

If the component arrangement is pre-hemmed in a pre-hemming step with a pre-hemming force 15, the following further parameters are advantageously recorded after pre-hemming, as shown as an example in FIG. 3b, in particular the pre-hemming angle 33 achieved, i.e. the angle which the now partially formed hemming flange 301 has to the first component 51 resting against the second component 52, and the roll-in value 30, i.e. the shortest distance which the outermost point of the partially formed hemming flange 301 has to a straight line running through the reference point 60, which runs parallel to the still unformed hemming flange 302.

If the component arrangement is completely hemmed after a hemming step with a hemming force 16, as shown as an example in FIG. 3c, the roll-in value 30 is recorded. Furthermore, the flange width 39 is recorded, i.e. the width of the fully formed flange 301. In addition, the packing dimension 31 is recorded, i.e. the total thickness of component 51 and component 52 in the area of the formed hemming flange 301. The outer radius with which the hemming flange 301 is formed can be recorded as a further parameter, wherein the recording is preferably carried out for different quadrants. Advantageously, an outer radius 32, with which the hemming flange 301 is formed, is therefore detected for a first quadrant, and an outer radius 29, with which the hemming flange 301 is formed, is detected for a second quadrant. Furthermore, the position 36 of the hemmed component 51 relative to the defined reference point 60 can be detected.

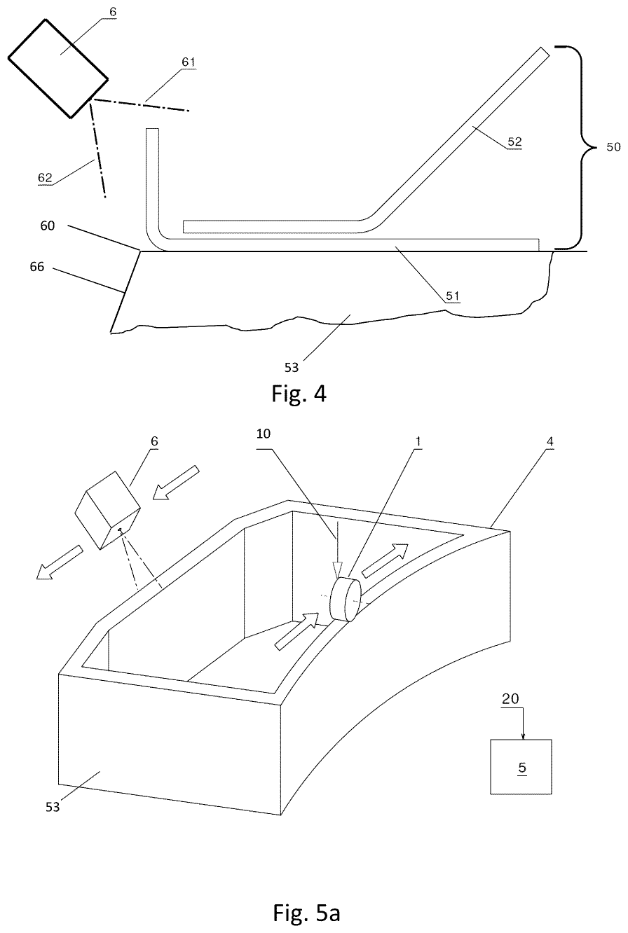

FIG. 4 shows an optical system 6 with which the actual geometry can be detected, for example by means of laser triangulation (shown symbolically in FIG. 4 by two laser beams 61, 62).

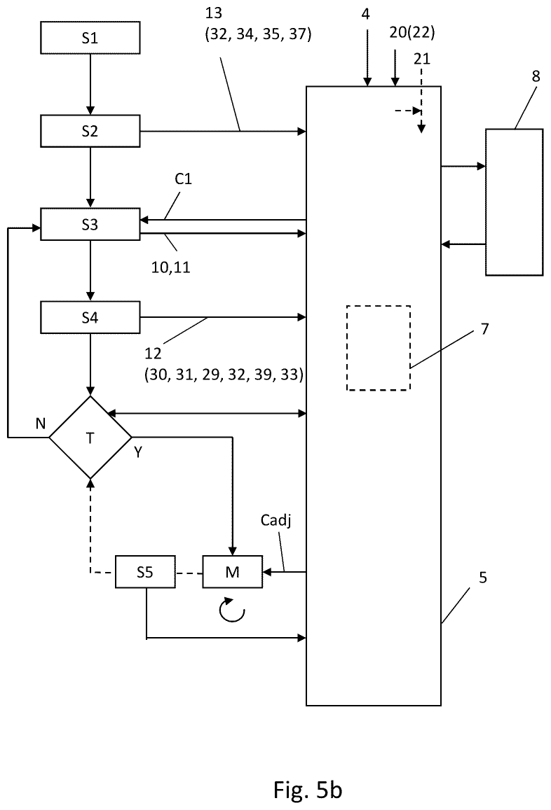

With reference to FIG. 5a and FIG. 5b, an exemplary embodiment of a roller hemming method designed according to the invention for hemming a plurality of identical component arrangements 50 is explained below. As shown schematically in FIG. 5a, in the roller hemming process, a hemming roller 1 arranged on a robot (not shown in FIG. 5a) is guided by the robot in accordance with a set roller hemming process with a predetermined hemming path 4 for forming a hemming flange of a component of a component arrangement 50. The method and thus the robot in particular are controlled by a control unit 5. To ensure that the hemming result of the roller hemming process corresponds to a predetermined hemming quality, it is necessary to set the roller hemming process precisely. For this purpose, a method for setting a roller hemming process for hemming the plurality of identical component arrangements 50 is provided in this exemplary embodiment and is explained in greater detail with reference to the flow diagram shown in FIG. 5b. The setting of the roller hemming process is controlled using the control unit 5, which can be designed in particular as an ECU (ECU: electronic control unit).

To set the roller hemming process, a component arrangement 50 with a first component 51 and a second component 52 is first provided in a step S1, as is also to be processed later by the roller hemming process in large quantities. For this component arrangement 50, the actual geometry 13 of the still unformed hemming flange 302 is recorded during a measuring run S2. In this exemplary embodiment, the measuring run S2 is carried out by means of the robot based on the hemming path 4 provided for the specific component arrangement 50, wherein an optical system arranged on the robot hemming head of the robot detects an opening angle 34, a flange length 38, a block clearance dimension 37, an outer radius 32 and a position 35 of the unhemmed component relative to a defined reference point as parameters for the actual geometry 13 of the still unformed hemming flange 302 and transmits them to the control unit 5. The hemming path 4 is described in the control unit 5 by a finite number of points representing the hemming path 4, wherein the parameters 32, 34, 35, 37 recorded for the respective point are assigned to each point of the hemming path 4.

In a next step S3, the hemming roller 1 arranged on the robot for forming the hemming flange of the component of the component arrangement 50 is guided by the robot in accordance with a predetermined hemming path 4, wherein the robot is controlled for this purpose by the control unit 5 with a control signal C1 generated by the control unit 5. The control signal C1, which can also be described as a sequence of control signals for a complete hemming run in accordance with the hemming path 4, is based in particular on a hemming path 4 specified to the control unit 5, a target hemming quality 20 specified to the control unit 5, which in this exemplary embodiment is defined by a target geometry of the fully formed hemming flange with the following parameters: flange width 39, packing dimension 31, position 36 of the hemmed component relative to a specified reference point, roll-in value 30, outer radius 32 for a first quadrant and an outer radius 29 for a second quadrant. The parameters for the target geometry of the formed hemming flange are each assigned to an associated point of the hemming path 4 for the entire hemming path 4. The control signal C1 specifies, among other things, a target hemming process force 21 to be achieved with which the hemming roller 1 should act on the hemming flange during forming. The target hemming process force 21 can be initially specified to the control unit for each point of the hemming path 4 and is then determined by the control unit 5 itself for each point of the hemming path 4 during the subsequent process. In particular, however, it can also be provided that the target hemming process force 21 is also initially determined by the control unit 5, taking into account a stiffness model 7 stored in the control unit 5, wherein the stiffness model 7 takes into account in particular the robot geometry and robot properties up to the hemming roller, in particular changing stiffnesses of the robot over the hemming path and the resulting changing spring constants of the robot.

During the forming of the hemming flange in step S3, the actual hemming process force 10 exerted by the robot and acting on the hemming roller 1 during hemming along the hemming path 4 is also detected and the detected hemming process force 10 is transmitted to the control unit 5. The actual hemming process force 10 detected at this point is assigned for each point of the hemming path 4. Furthermore, an actual hemming path 11 of the hemming roller 1 is recorded during the forming process and transmitted to the control unit 5. The points of the hemming path and the parameters recorded for each point can advantageously be recorded as value tuples. In this respect, the control unit 5 works in particular with displacements of the hemming path as an input variable.

After a hemming operation along the complete hemming path 4 has been completed, wherein a final hemming operation is provided as the hemming operation in this exemplary embodiment (alternatively, a pre-hemming operation could also be provided), a measuring run S4 takes place, with which the actual geometry 12 of the formed hemming flange is recorded by means of the optical system arranged on the robot hemming head. For this purpose, the following parameters are recorded and transmitted to the control unit 5: a roll-in value 30, a packing dimension 31, an outer radius 32 for a first quadrant, an outer radius 29 for a second quadrant. The parameters are also each assigned to an associated point on the hemming path 4. In one embodiment of the method, in which a hemming operation can also be a pre-hemming operation, a pre-hemming angle 30 achieved is also recorded in particular as a parameter of the actual geometry 12 of the formed hemming flange.

After the measuring run S4, the control unit 5 evaluates in a step T whether the detected actual geometry 12 corresponds to the specified target geometry 22, wherein the actual geometry 12 already corresponds to the specified target geometry 22 if the actual geometry 12 deviates from the target geometry 22 within defined tolerance bands. If the detected actual geometry 12 does not correspond to the target geometry 22 (labelled “N” in FIG. 5b), a hemming operation is carried out again in a step S3 by a correspondingly modified control of the robot for a new but identical component arrangement, wherein an adjustment of the hemming roller 1 by means of the robot is varied by an adapted control signal C1. The control signal C1 is adapted to achieve the target hemming quality 20, in this case to achieve the target geometry 22, taking into account the actual hemming process force 10, the actual hemming path 11 and the actual geometry 12 of the formed hemming flange. The actual variables recorded during a hemming operation, in particular the parameters of the actual geometry 12 of the formed hemming flange, are therefore brought closer to the target variables, in particular the parameters of the target geometry 22 for a formed hemming flange, in a subsequent further hemming operation.

After step S3 has been carried out, another measuring run S4 is carried out and the hemming result is evaluated in a step T. As long as this evaluation in step T shows that the detected actual geometry 12 does not correspond to the target geometry 22 (N), the steps are repeated. If, on the other hand, the evaluation T shows that the detected actual geometry 12 of the formed hemming flange corresponds to the target geometry 22 for a formed hemming flange (labelled “Y” in FIG. 5b), the roller hemming process is set, in particular for a subsequent roller hemming in a step M. In this roller hemming M, the same component arrangement is carried out with the control signal Cadj set in the upstream method steps. After a predetermined number of identical component arrangements have been hemmed in a step M, wherein the number can be 200, for example, a measuring run S5 can be carried out for quality assurance, wherein it is then evaluated in step T whether a detected actual geometry 12 of the formed hemming flange still corresponds to the target geometry 22 for a formed hemming flange. If this is the case (Y), the roller hemming process continues unchanged with step M. If, on the other hand, the actual geometry 12 of the formed hemming flange no longer corresponds to the target geometry 22 for the formed hemming flange (N), steps S3, S4 and T are carried out again. The roller hemming process is thus set again.

According to one variant of the method described with reference to FIG. 5b, the hemming process can also be simulated in a computer-aided simulation model 8. The simulation model 8 takes into account the material-specific parameters of the component arrangement, the component dimensions and component geometry before hemming and works with forces as an input variable, whereas the control unit 5 for controlling the robot 2 advantageously works with displacements in relation to the hemming path as an input variable. The stiffness model 7 advantageously “mediates” between the two. The actual variables recorded during the measurement runs S2, S4, S5 and transmitted to the control unit 5 are forwarded from the control unit 4 to the simulation model 8. These real actual variables are then used by the simulation model 8 to carry out simulations of the hemming process, wherein an adjustment of the hemming roller 1 to be implemented with the robot is simulated, taking into account these real actual variables and the target geometry 22 to be achieved, until the target geometry is achieved in the simulation model 8. Advantageously, the next real hemming operation is then carried out in step S3 with the position of the hemming roller 1 simulated in the simulation model, i.e. a correspondingly adapted control signal C1. If, after the measuring run S4 and the evaluation T, it is found that a target hemming quality has not been achieved, the simulation model 8 is advantageously adapted taking into account the actual variables recorded during the measuring run and the actual hemming process force recorded during hemming in step S3. Advantageously, the number of real hemming operations according to step S3 and measuring runs according to S4 can be reduced by the computer-aided simulations, which makes the setting of the roller hemming process even more cost-effective and faster.

The exemplary embodiments shown in the figures and explained in conjunction therewith serve to illustrate the invention and are not limiting with respect thereto.

### LIST OF REFERENCE SIGNS

1 hemming roller
2 robot
201 robot link
202 robot link
3 hemming flange
301 formed hemming flange
302 unformed hemming flange
4 hemming path
5 control unit
6 optical system
7 stiffness model
8 simulation model
10 actual hemming process force
11 actual hemming path
12 actual geometry of a formed hemming flange (301)
13 actual geometry for a still unformed hemming flange (302)
15 pre-hemming force
16 final hemming force
20 target hemming quality
21 target hemming process force
22 target geometry
29 outer radius in quadrant 2
30 roll-in value
31 packing dimension
32 outer radius in quadrant 1
33 achieved pre-hemming angle
34 opening angle
35 position of the unhemmed component in relation to a defined reference point
36 position of the hemmed component in relation to a defined reference point
37 block clearance dimension
38 flange length
39 flange width
40 robot hemming head
41 attachment element
42 connecting element
43 head element
44 measuring body
45 sensor
50 component arrangement
51 first component
52 second component
53 hemming bed
60 reference point
61 laser beam
62 laser beam
66 reference surface
100 roller hemming device
S1 provision of a component arrangement as intended for series production
S2 measuring run to record the actual geometry of an unformed hemming flange
S3 execution of a hemming operation according to a specification
S4 measuring run to record the actual geometry of a formed hemming flange
S5 measuring run to record the actual geometry of a formed hemming flange in the set roller hemming process
T evaluation of whether the recorded actual hemming quality corresponds to the specified target hemming quality
M execution of a hemming operation with the roller hemming process completed
C1 control signal
Cadj set control signal

1. A method for setting a roller hemming process for hemming a plurality of identical component arrangements, comprising:
guiding a hemming roller arranged on a robot using the robot in accordance with a predetermined hemming path in order to form a hemming flange of a component of a component arrangement, wherein the robot can be controlled by a control unit to influence a hemming quality of the formed hemming flange;
detecting an actual hemming process force acting on the hemming roller by the robot during forming, wherein the hemming process force can be changed by a corresponding control of the robot by the control unit; and
controlling the robot, by the control unit, to achieve a predetermined target hemming quality, taking into account the detected actual hemming process force and an actual geometry of a formed hemming flange resulting from the forming.

2. The method according to claim 1, wherein the hemming path is also detected during the forming.

3. The method according to claim 1, wherein the hemming path for the control of the robot by the control unit is described by a finite number of points representing the hemming path.

4. The method according to claim 3, wherein each point of the hemming path is assigned a target hemming process force, the actual hemming process force detected at this point, a target geometry for a formed hemming flange, and an actual geometry of a formed hemming flange detected at this point.

5. The method according to claim 1, further comprising detecting an actual geometry for a still unformed hemming flange before a forming of the hemming flange.

6. The method according to claim 1, wherein the geometry is detected by an optical system and/or by a haptic system.

7. The method according to claim 1, wherein an actual hemming path is determined from the detected actual hemming process force and from the detected actual geometry.

8. The method according to claim 1, wherein an actual hemming path is determined by measurement.

9. The method according to claim 1, wherein the robot has a robot hemming head with an attachment element, a connecting element and a head element, on which the hemming roller is arranged, wherein the connecting element is arranged between the attachment element and the head element, wherein at least a part of the connecting element is designed as a measuring body, wherein the measuring body detects the actual hemming process force with at least one sensor element arranged on the measuring body.

10. The method according to claim 1, wherein a valid stiffness model for the robot is assigned to the predetermined hemming path.

11. The method according to claim 1, wherein at least one of the following criteria is recorded for the geometry of the hemming flange: a roll-in value; a packing dimension; an outer radius; an achieved pre-hemming angle; an opening angle; a position of the unhemmed component relative to a fixed reference point; a position of the hemmed component relative to a fixed reference point; a block clearance dimension; a flange length; a flange width.

12. The method according to claim 1, wherein an adjustment of the hemming roller is varied by the robot in order to achieve the target hemming quality.

13. The method according to claim 1, wherein the actual variables recorded during a first hemming operation are brought closer to the target variables in a subsequent second hemming operation.

14. The method according to claim 1, wherein, taking into account actual variables detected during a first hemming operation for already hemmed points of the hemming path for subsequent points of the hemming path, the robot is controlled in such a way that the difference between actual variables and target variables is reduced.

15. The method according to claim 1, wherein the hemming process is additionally simulated in a computer-aided simulation model, wherein detected actual variables are transferred to the simulation model, and variables for the actual variables on which the simulation model is based are replaced by the transferred actual variables, an adjustment of the hemming roller to be implemented with the robot is simulated, taking into account these actual variables and the target hemming quality to be achieved, until the target hemming quality is achieved in the simulation model, and the next hemming operation is carried out with this simulated adjustment of the hemming roller.

16. The method according to claim 15, wherein certain simulation values are specified by the computer-aided simulation model as initial process control parameters for the method for setting a roller hemming process.

17. The method according to claim 1, wherein the method is carried out as a method for optimizing a hemming quality and/or as an intermediate method for ensuring a hemming quality.

18. A roller hemming method for hemming a plurality of identical component arrangements, wherein a hemming roller arranged on a robot for forming a hemming flange of a component of a component arrangement is guided by the robot in accordance with a set roller hemming process with a predetermined hemming path, wherein the roller hemming process is set in accordance with the method according to claim 1.

19. A roller hemming device comprising a hemming robot with at least one hemming roller arranged on a robot hemming head, a control unit, and a measuring system, wherein the roller hemming device is designed to carry out the method according to claim 1.
